(19) United States
(12) Patent Application Publication
(10) Pub. No.: US 2022/0189216 A1
(43) Pub. Date: Jun. 16, 2022

(54) SAFE DRIVING LEVEL EVALUATION DEVICE

(71) Applicant: TOYOTA JIDOSHA KABUSHIKI KAISHA, Toyota-shi (JP)

(72) Inventors: Masaaki YAMAOKA, Tokyo-to (JP); Evan CUSHING, Tokyo-to (JP); Florin BAIDUC, Chiba-shi (JP)

(21) Appl. No.: 17/548,646

(22) Filed: Dec. 13, 2021

(30) Foreign Application Priority Data
Dec. 14, 2020 (JP) 2020-206891

(51) Int. Cl. G07C 5/06

(52) U.S. Cl. CPC G07C 5/06

(57) ABSTRACT

A safe driving level evaluation device for evaluating a safe driving level of a driver, includes: a surrounding environment recognizing part for recognizing a surrounding environment of a vehicle; an ideal running route calculating part for calculating an ideal running route, including an ideal running position and an ideal running speed, based on the recognized surrounding environment; an actual running route detecting part for detecting an actual running route, including an actual running position and an actual running speed; an indicator value calculating part for calculating a safety indicator value so that it becomes a value indicating a safe driving level is lower when a difference between the ideal running route and the actual running route is large, compared to when it is small; and a safe driving level estimating part for estimating a safe driving level based on the safety indicator value calculated.

### FIELD

The present disclosure relates to a safe driving level evaluation device.

### BACKGROUND

Evaluating the driving of a driver based on the surrounding environment of a vehicle and the driving operation of the driver, has been studied in the past (for example, JP 2019-28534 A, JP 2010-257234 A, and JP 2009-288941 A). For example, JP 2019-28534 A discloses to evaluate whether a required safe driving operation has been achieved for each driving scene to calculate a safe driving score and to show that score on a display. In particular, in JP 2019-28534 A, for example, the safe driving score is calculated based on whether the driver stops temporarily at an intersection, checks the left and right, and otherwise actually observes safe driving practices.

### SUMMARY

In this regard, in the device described in JP 2019-28534 A, for example, the same extent of safe driving score is calculated both in the case of stepping hard on the brake to decelerate and temporarily stop, and the case of gradually decelerating and temporarily stopping. However, in these cases, if considering the safety of driving operations, the safe driving scores should be made different. Accordingly, in the device described in JP 2019-28534 A, the safe driving level of a driver could not necessarily be suitably evaluated. Therefore, a method different from the method of evaluation of the safe driving level according to the device described in JP 2019-28534 A is considered necessary.

In consideration of the above problem, an object of the present disclosure is to provide a safe driving level evaluation device for evaluating a safe driving level of a driver by a new technique.

The present invention has as its gist the following.

(1) A safe driving level evaluation device for evaluating a safe driving level of a driver, comprising:

a surrounding environment recognizing part for recognizing a surrounding environment of a vehicle;

an ideal running route calculating part for calculating an ideal running route of the vehicle, including an ideal running position and an ideal running speed of the vehicle, based on the recognized surrounding environment;

an actual running route detecting part for detecting an actual running route of the vehicle, including an actual running position and an actual running speed of the vehicle;

an indicator value calculating part for calculating a safety indicator value so that it becomes a value indicating a safe driving level is lower when a difference between the ideal running route and the actual running route is large, compared to when it is small; and

a safe driving level estimating part for estimating a safe driving level based on the safety indicator value calculated.

(2) The safe driving level evaluation device according to above (1), further comprising a display part for making a display relating to the estimated safe driving level be shown on a display of the vehicle.

(3) The safe driving level evaluation device according to above (1) or (2), wherein

the indicator value calculating part calculates the safety indicator value so that the safety indicator value inverts in sign between a case where a difference between the ideal running route and the actual running route is equal to or greater than a predetermined reference difference and a case where it is less than the reference difference, and

the safe driving level estimating part estimates a safe driving level based on a cumulative value of the safety indicator values in a predetermined section of a running route.

(4) The safe driving level evaluation device according to any one of above (1) to (3), wherein the indicator value calculating part calculates the safety indicator value so that the longer the distance between each running position on the ideal running route and the corresponding running position on the actual running route, the lower the safe driving level indicated by the value.

(5) The safe driving level evaluation device according to any one of above (1) to (4), wherein the indicator value calculating part calculates the safety indicator value so that the larger the difference between the running speed at each running position on the ideal running route and the running speed at the corresponding running position on the actual running route, the lower the safe driving level indicated by the value.

(6) The safe driving level evaluation device according to any one of above (1) to (4), wherein

the indicator value calculating part calculates the safety indicator value so that the safety indicator value inverts in sign between a case where a distance between each running position on the ideal running route and the corresponding running position on the actual running route is equal to or greater than a predetermined reference distance and a case where it is less than the reference distance, and

the reference distance changes according to a width of a road or a lane on which the vehicle runs.

(7) The safe driving level evaluation device according to any one of above (1) to (6), wherein

the indicator value calculating part calculates the safety indicator value so that the safety indicator value inverts in sign between a case where a speed difference between a running speed at each running position on the ideal running route and a running speed at the corresponding running position on the actual running route is equal to or greater than a predetermined reference speed difference and a case where it is less than the reference speed difference, and

the reference speed difference changes according to the running speed at the running position of the ideal running route of the vehicle.

(8) The safe driving level evaluation device according to any one of above (1) to (7), wherein the indicator value calculating part calculates the safety indicator value to indicate a lower safe driving level for the same speed difference in a case where a running speed at each running position on the actual running route is faster than the running speed at the corresponding running position on the ideal running route, compared to a case where a running speed at each running position on the actual running route is slower than the running speed at the corresponding running position on the ideal running route.

### BRIEF DESCRIPTION OF DRAWINGS

FIG. 1 is a view of the configuration schematically showing a safe driving level evaluation system according to one embodiment.

FIG. 2 is a view schematically showing an instrument panel provided in a vehicle.

FIG. 3 is a view of a hardware configuration of an ECU according to one embodiment.

FIG. 4 is a view schematically showing a running route in a case where there is a parked vehicle on a road with a single lane for each direction.

FIG. 5 is a view showing a relationship between a distance between a running position on an ideal running route and a corresponding running position on an actual running route, and a safety indicator value.

FIG. 6 is a view showing a relationship between a speed difference between a running speed at a point on an ideal running route and a running speed on a corresponding point on an actual running route, and a safety indicator value.

FIG. 7 is a functional block diagram of a processor of an ECU relating to processing for evaluation of a safe driving level of a driver.

### DESCRIPTION OF EMBODIMENTS

Below, referring to the drawings, embodiments will be explained in detail. Note that, in the following explanation, similar component elements are assigned the same reference notations.

Configuration of Safe Driving Level Evaluation System

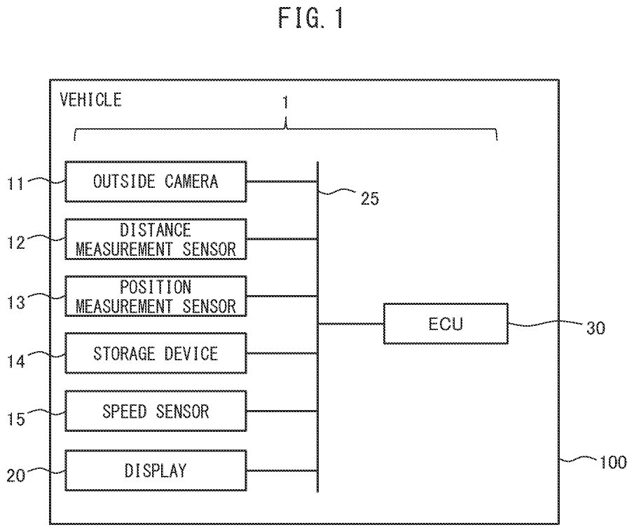

First, referring to FIG. 1 to FIG. 3, the configuration of a safe driving level evaluation system 1 in which a safe driving level evaluation device for evaluating a safe driving level of a driver is mounted, will be explained.

However, the safe driving level evaluation system 1 need not necessarily have all of them. For example, the safe driving level evaluation system may not necessarily have the distance measurement sensor 12 or speed sensor 15, as long as it has the outside camera 11.

The outside camera 11, distance measurement sensor 12, position measurement sensor 13, storage device 14, speed sensor 15, display 20, and ECU 30 are connected to be able to communicate through an inside network 25. The inside network 25 is a network based on the CAN (Controller Area Network) or other standard.

The outside camera 11 is a device capturing an image of the surroundings of the vehicle. The outside camera 11 has 2D detectors (CCD, C-MOS, etc.) configuring an array of photoelectric conversion elements having sensitivity to visible light, and an image-forming optical system forming an image of a region for capture on the 2D detectors. In the present embodiment, the outside camera 11 is, for example, arranged in the vehicle 100 so as to face the front of the vehicle 100. The outside camera 11 captures an image of the area in front of the vehicle 100 at every predetermined image capturing period (for example 1/30 second to 1/10 second), and generates an image in which the front area is captured. The outside camera 11 outputs a generated image through the inside network 25 to the ECU 30 every time generating an image. Note that, the outside camera 11 may be a single lens camera or a stereo camera. If a stereo camera is used as the outside camera 11, the outside camera 11 functions as the distance measurement sensor 12. The vehicle 100 may also be provided with a plurality of outside cameras different in directions of capture or focal distances.

The distance measurement sensor 12 is a sensor measuring the distance to an object present in the surroundings of the vehicle 100. In the present embodiment, the distance measurement sensor 12 can also measure the orientation toward an object present in the surroundings of the vehicle 100. The distance measurement sensor 12 is, for example, a milliwave radar or other radar, or LIDAR. The milliwave radar emits an electromagnetic wave of a wavelength in mm units in pulses or continuously while modulating its frequency, and measures the reflected wave of that electromagnetic wave to measure the position of an object in a measurement range. Further, a LIDAR measures the reflected beam of a laser beam emitted in a pulse manner to measure the position of an object in a measurement range. The distance measurement sensor 12, for example, is arranged at a front end part of the vehicle 100 (for example, inside the front bumper) and measures a distance to an object present in front of the vehicle 100. The distance measurement sensor 12 measures the distance to an object in the surroundings of the vehicle 100 for each predetermined period, and outputs the measurement results through the internal vehicle network 25 to the ECU 30.

The position measurement sensor 13 is a sensor for measuring the self position of the vehicle 100. The position measurement sensor 13 is, for example, a GPS (global positioning system) receiver. The GPS receiver receives GPS signals from a plurality of GPS satellites, and measures the self position of the vehicle 100 based on the received GPS signals. The position measurement sensor 13 outputs the results of measurement of the self position of the vehicle 100 to the ECU 30 through the inside network 25 every predetermined period. Note that, the position measurement sensor 13 may also be a receiver based on another satellite position measurement system if possible to measure the self position of the vehicle 100.

The storage device 14, for example, has a hard disk device or nonvolatile semiconductor memory. The storage device 14 stores the map information. The map information includes information expressing the positions and road signs of predetermined sections of the road for every such section (for example, road lane lines or stop lines). The storage device 14 reads out map information in accordance with a readout demand of map information from the ECU 30, and sends the map information to the ECU 30 through the inside network 25.

The speed sensor 15 is a sensor for detecting a running speed of the vehicle 100. The speed sensor 15, for example, detects a rotational speed of a shaft connected to the tires, and detects the running speed of the vehicle 100 based on the detected rotational speed.

The display 20 is a display device displaying information relating to the operation of the vehicle 100. The display 20, for example, is a liquid crystal display or organic EL display or other device displaying an image on a screen. Alternatively, the display 20 may be a head-up display projecting an image on the front window glass of the vehicle 100 or another transparent plate provided at the front of the driver. Whatever the case, the display 20 may be any type of display so long as able to display an image. The display 20 is connected through the inside network 25 to the ECU 30. The display 20 receives a display signal from the ECU 30, and displays an image corresponding to the received display signal.

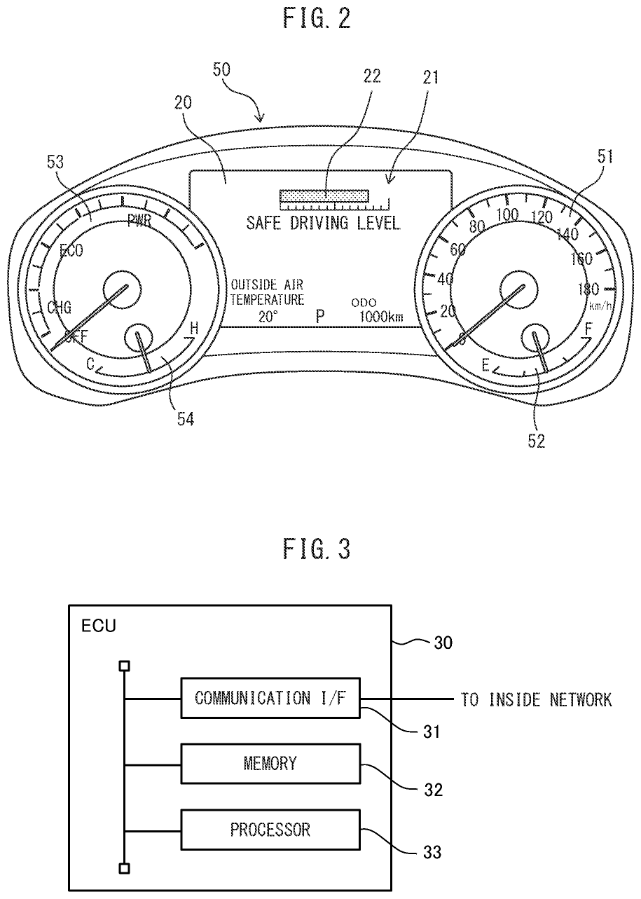

FIG. 2 is a view schematically showing an instrument panel 50 provided inside the vehicle 100. The instrument panel 50 shown in FIG. 2 is arranged so as to be positioned at the front of the driver inside the vehicle 100.

As shown in FIG. 2, the instrument panel 50 is provided with a speedometer 51 displaying a speed, a fuel gauge 52 displaying a remaining amount of fuel, a hybrid system indicator 53 showing an output of a hybrid system and a power regeneration level, and a water temperature gauge 54 showing a cooling water temperature of an internal combustion engine. In addition, the instrument panel 50 is provided with a display 20 among these speedometer 51, fuel gauge 52, hybrid system indicator 53, and water temperature gauge 54.

As shown in FIG. 2, the display 20 shows a graphic 21 relating to the safe driving level. The graphic 21 has an indicator 22 changing in length in accordance with a safe driving level of a driver estimated by the later explained safe driving level evaluation device. The indicator 22, for example, becomes longer as the safe driving level becomes higher. The graphic 21, for example, is shown when the driver has finished operating the vehicle 100 or when selected by the driver. The display 20 shows various warnings and other various information in addition to information relating to the safe driving level.

Note that, in the present embodiment, the estimated safe driving level of a driver is shown by the indicator 22. However, the graphic 21 may be shown in another mode so long as changing in accordance with the estimated safe driving level. Therefore, the graphic 21 may, for example, also be text showing the safe driving level (numerical values, words indicating the level, etc.)

The ECU 30 is a processing device which receives data from various sensors such as the outside camera 11, the distance measurement sensor 12, and the position measurement sensor 13 and consequently controls the display 20 and various other equipment. The ECU 30 functions as a safe driving level evaluation device for evaluating a safe driving level of a driver. FIG. 3 is view of the hardware configuration of the ECU 30 of one embodiment of the safe driving level evaluation device. The ECU 30 has a communication interface 31, memory 32, and processor 33. Note that, the communication interface 31, memory 32, and processor 33 may be separate circuits or may be configured as a single integrated circuit.

The communication interface circuit 31 is a circuit for connecting the ECU 30 to the inside network 25. The communication interface 31 sends an image received from the outside camera 11 to the processor 33, each time receiving that image. Further, the communication interface 31 sends the result of measurement of the distance to an object in the surroundings of the vehicle from the distance measurement sensor 12 to the processor 33, each time receiving the results of measurement. In addition, the communication interface 31 sends the result of measurement of the self position from the position measurement sensor 13, each time receiving the result of measurement. Further, the communication interface 31 sends a high precision map information read from the storage device 14 to the processor 33. Further, the communication interface 31 sends a speed signal received from the speed sensor 15 to the processor 33. In addition, the communication interface 31 sends a display signal received from the ECU 30 to the display 20, each time receiving that display signal.

The memory 32 is a storage device storing data. The memory 32, for example, has a volatile semiconductor memory and nonvolatile semiconductor memory. The memory 32 stores a program of driver assistance processing to be performed by the processor 33 of the ECU 30. Further, the memory 32 stores images captured by the outside camera 11, results of measurement of the distance to an object in the surroundings of the vehicle, different types of data used in the display processing, etc.

The processor 33 has one or more CPUs (central processing units) and their peripheral circuits. The processor 33 may further have other processing circuits such as logical processing units or numerical processing units. The processor 33 performs display processing of the display 20 to control the display 20.

Evaluation of Safe Driving Level

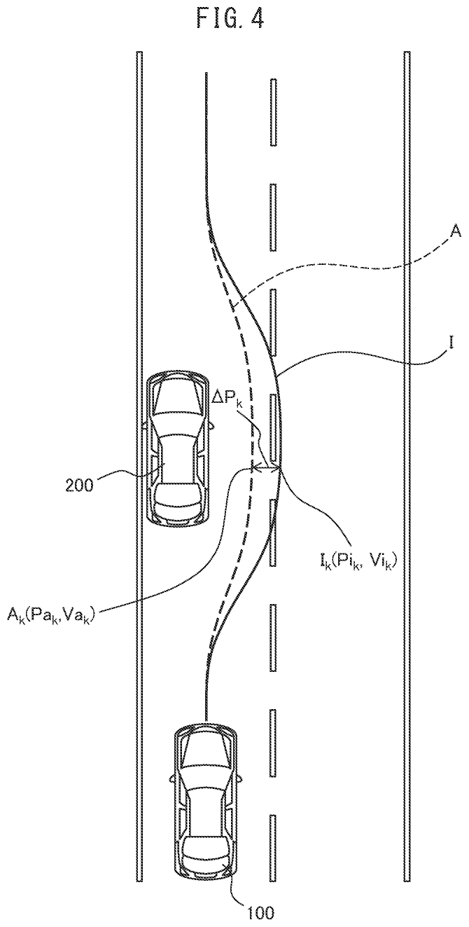

Next, referring to FIGS. 4 to 6, a method for evaluating a safe driving level of a driver will be explained. In the present embodiment, the ideal running route of the vehicle 100 (below, referred to as the “ideal running route”) is calculated based on the surrounding environment of the vehicle 100, etc. The safe driving level is estimated based on the difference of the actual running route of the vehicle 100 (below, referred to as the “actual running route”) from the ideal running route. In the present embodiment, the smaller the difference between the actual running route and the ideal running route, the higher the safe driving level is estimated as being. Below, the technique for estimating the safe driving level will be specifically explained.

In the present embodiment, first, the ECU 30 of the vehicle 100 recognizes the surrounding environment of the vehicle 100, based on the outputs of the various sensors (outside camera 11, distance measurement sensor 12, etc.) The “surrounding environment” includes information on the road on which the vehicle 100 is running (number of lanes, width of lanes, road surface conditions, etc.), information on objects in the surroundings of the vehicle 100 (other vehicles, pedestrians, obstacles, etc.), etc.

After that, the ideal running route of the vehicle 100 is calculated based on the recognized surrounding environment. Note that, in the present embodiment, the running route (running path) includes the running position of the vehicle 100 and the running speed at each running position.

FIG. 4 is a view schematically showing a running route in a case where there is a parked vehicle 200 on a road with a single lane in each direction. In the example shown in FIG. 4, the case is shown where a parked vehicle 200 is stopped on the running lane on which the vehicle 100 is running. Therefore, the vehicle 100 avoids the parked vehicle 200 by running while temporarily swinging out into the oncoming lane, then returns to its original running lane. The solid line in the figure shows the ideal running route I calculated based on the recognized surrounding environment. In the example shown in FIG. 4, the ideal running route I is shown as a continuous straight line, but in actuality it is a set of point group data for the different points at predetermined distances. The data of the points includes information on the ideal running position and ideal running speed at the points.

As shown in FIG. 4, the ideal running route I is the route by which, in the region in the surroundings of the parked vehicle 200, the vehicle 100 runs along a position away from the vehicle 200 to an extent enabling enough of a distance to be secured for being able to handle even a pedestrian popping out from behind the parked vehicle 200 of the vehicle 100, and sufficiently lowered in speed. Further, the ideal running route I is a route by which the vehicle 100 speedily returns to its original running lane after passing the parked vehicle 200 and, after returning to its original running lane, is restored in speed. The data of any point Iₖ of the ideal running route I includes the information of the ideal running position at that point Iₖ (coordinate information) and information of the ideal running speed at that point Iₖ (note that, “k” indicates the order of the point groups on the ideal running route in the evaluation section where the safe driving level is evaluated). In the example shown in FIG. 4, the running position at any point Iₖ on the ideal running route I is represented by Piₖ, and the running speed at the point Iₖ is represented by Viₖ.

On the other hand, the broken line in FIG. 4 shows an example of an actual running route A over which the vehicle 100 actually runs. The actual running route A shows the running route in case where in the region in the surroundings of the parked vehicle 200, the vehicle 100 has run along a position closer to the parked vehicle 200 compared with the ideal running route I and has run by the same extent of speed. As shown in FIG. 4, the running position at the point Aₖ on the actual running route A corresponding to any point Iₖ on the ideal running route I (that is, the point on the actual running route A closest from any point Iₖ on the ideal running route I (where the distance between the running positions is the shortest)) is shown by Paₖ, and the running speed at the point Aₖ is shown by Vaₖ.

Therefore, the running position Paₖ of the point Aₖ on the actual running route A of the vehicle 100 is separated by the distance ΔPₖ from the running position Piₖ of the corresponding point Iₖ on the ideal running route I. Further, the running speed Vaₖ of the point Aₖ on the actual running route A of the vehicle 100 differs by the speed difference ΔVₖ from the running speed Viₖ of the corresponding point Iₖ of the ideal running route I. The absolute values of these distance ΔPₖ and speed difference ΔVₖ express how much the actual running route A differs from the ideal running route I. Specifically, the smaller the absolute values of these distance ΔPₖ and speed difference ΔVₖ, the closer the actual running route A is to the ideal running route I.

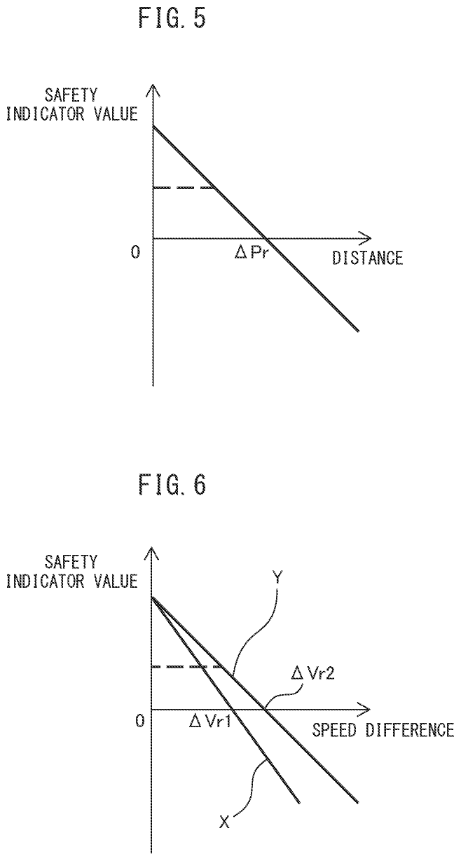

Therefore, in the present embodiment, the safety indicator value Isₖ at each point Iₖ of the ideal running route I is calculated based on the distance ΔPₖ and the speed difference ΔVₖ between the two routes at the point Iₖ, and the safe driving level LV is estimated based on the calculated safety indicator value Isₖ. In particular, the larger the safety indicator value Isₖ in the present embodiment, the higher the safe driving level it expresses. The safety indicator value Isₖ is calculated based on the relationships shown in FIGS. 5 and 6. Note that, safety indicator value Isₖ may also be an indicator value showing a lower safe driving level as the safety indicator value Isₖ is larger.

FIG. 5 is a view showing a relationship between a distance ΔPₖ between a running position Piₖ at each point Iₖ on an ideal running route I and a corresponding running position Paₖ at a corresponding point Aₖ on an actual running route A, and a safety indicator value Is. Note that, below, the running position, running speed, distance, and speed difference at any point will sometimes be referred to without the “k”.

As shown in FIG. 5, in the present embodiment, the relationship between the distance ΔP and the safety indicator value Is is set so that the safety indicator value Is is the largest when the distance ΔP between the two running positions is 0, and so that the safety indicator value Is is smaller as the distance ΔP between the two running positions is larger. In particular, in the present embodiment, the safety indicator value Is is smaller proportionally to the distance ΔP between the two running positions being larger. Further, in the present embodiment, the sign of the safety indicator value Is inverts between the case where the distance ΔP between the two running positions is equal to or greater than a predetermined reference distance ΔPr and the case where the distance ΔP between the two running positions is less than a predetermined reference distance ΔPr. In particular, in the present embodiment, the safety indicator value Is changes from plus to minus if the distance ΔP between the two running positions becomes equal to or greater than a predetermined reference distance ΔPr.

Note that, in the present embodiment, the safety indicator value Is is smaller proportionally to the distance ΔP between the two running positions being larger. However, the safety indicator value Is need not necessarily change proportionally to the distance ΔP. For example, the safety indicator value Is, as shown in FIG. 5 by the broken line, may be a constant value not changing in accordance with the distance ΔP when the distance ΔP is equal to or less than a predetermined value. Further, in the present embodiment, the relationship between the distance ΔP between the two running positions and the safety indicator value Is is similar both when the actual running route A is to the left or right of the ideal running route I. However, the relationship between the distance ΔP between the two running positions and the safety indicator value Is may also be set so as to differ depending on whether the actual running route A is either to the left or right of the ideal running route I. For example, in the state shown in FIG. 4, the reference distance ΔPr in the case where the actual running route A is at the right side of the ideal running route I (opposite side to parked vehicle 200) may be larger than the reference distance ΔPr in the case where the actual running route A is at the left side of the ideal running route I (parked vehicle 200 side). This is because it is believed that when the actual running route A is shifted to the left side of the ideal running route I, the vehicle 100 will approach the parked vehicle 200, therefore the safety will be lower than the case shifted to the right side. In addition, the relationship between the distance ΔP between the two running positions and the safety indicator value Is may change in accordance with the running state of the vehicle 100. For example, the reference distance ΔPr may also change in accordance with the width of the road or lane over which the vehicle 100 is running. In this case, the reference distance ΔPr is set larger the larger the width of the road or the lane. This is because if the width of the road or lane is large, there is little effect on safety even if the actual running position has deviated somewhat from the ideal running position.

FIG. 6 is a view showing a relationship between a speed difference ΔV between a running speed Viₖ at a point Iₖ on an ideal running route and a running speed Vaₖ on a corresponding point Aₖ on an actual running route A, and a safety indicator value Is. The X in the figure shows the case where the running speed at the actual running route A is faster than the running speed at the ideal running route I, while the Y in the figure shows the case where the running speed at the actual running route A is slower than the running speed at the ideal running route I.

As shown in FIG. 6, in the present embodiment, the relationship between the speed difference ΔV and the safety indicator value Is is set so that when the speed difference ΔV is 0, the safety indicator value Is is the largest, and so that the safety indicator value Is is smaller as the speed difference ΔV is larger. In particular, in the present embodiment, the safety indicator value Is is smaller in proportion to the speed difference ΔV being larger. Further, in the present embodiment, in the case where the running speed at the actual running route A is faster than the running speed at the ideal running route I (X in figure), the sign of the safety indicator value Is inverts between when the speed difference ΔV is equal to or greater than a predetermined first reference speed difference ΔVr1 and when it is less than the first reference speed difference ΔVr1. On the other hand, in the case where the running speed at the actual running route A is slower than the running speed at the ideal running route I (Y in figure), the sign of the safety indicator value Is inverts between when the speed difference ΔV is equal to or greater than a predetermined second reference speed difference ΔVr2 and when it is less than the second reference speed difference ΔVr2.

In the present embodiment, the first reference speed difference ΔVr1 is smaller than the second reference speed difference ΔVr2. Therefore, in the present embodiment, in the case where the running speed at any running position at the actual running route A is faster than the running speed at the corresponding running position of the ideal running route I (X in figure), compared with the case where the running speed at any running position at the actual running route A is slower than the running speed at the corresponding running position of the ideal running route I (Y in figure), the safety indicator value Is is calculated to be smaller for the same speed difference. As a result, if the running speed at the actual running route A is faster than the running speed at the ideal running route I, the safety indicator value Is more easily becomes smaller, and the safe driving level more easily is judged low.

Note that, in the present embodiment, the safety indicator value Is is smaller proportionally to the speed difference ΔV being larger. However, the safety indicator value Is need not necessarily change proportionally to the speed difference ΔV. For example, the safety indicator value Is, as shown in FIG. 6 by the broken line, may be a fixed value not changing in accordance with the speed difference ΔV when the speed difference ΔV is equal to or less than a predetermined value. Further, the reference speed differences ΔVr1, ΔVr2 may also change in accordance with the running speeds at the different running positions of the ideal running route of the vehicle 100. In this case, the reference speed differences ΔVr1, ΔVr2 is greater as the running speed is faster. This is because the faster the speed of the vehicle 100, the smaller the effect on safety even if the actual running speed deviates somewhat from the ideal running speed. In addition, in the present embodiment, the safety indicator value for the speed difference differs between the case where the running speed at the actual running route A is faster than the running speed at the ideal running route I (X in figure) and the case where the running speed at the actual running route A is slower than the running speed at the ideal running route I (Y in figure). However, the safety indicator value for the speed difference may be set to be equal in both cases.

As explained above, utilizing the relationships such as shown in FIGS. 5 and 6, the safety indicator value Isₖ at the point Iₖ is calculated based on the distance ΔPₖ and the speed difference ΔVₖ between the two running positions for the different points Iₖ on the ideal running route I. The thus calculated safety indicator value Isₖ expresses the difference between the ideal running route I and the actual running route A at the different points Iₖ.

In the present embodiment, the difference between the ideal running route I and the actual running route A is calculated over a predetermined evaluation section of the ideal running route I. Therefore, the safety indicator value Isₖ is calculated for all points Iₖ (k=1, 2, . . . , K) on the ideal running route I in this evaluation section. Further, in the present embodiment, the value obtained by cumulatively adding all of the safety indicator values Isₖ calculated in this way is calculated as the safe driving level LV of a driver. The thus calculated safe driving level LV expresses the average magnitude of the difference between the ideal running route I and the actual running route A in the above predetermined evaluation section as a whole, and accordingly expresses the extent by which the driver is making the vehicle 100 run matching the ideal running route set by considering safety. Therefore, the value of the thus calculated safe driving level is a value suitably expressing the actual safe driving level of the driver.

Specific Processing for Evaluation

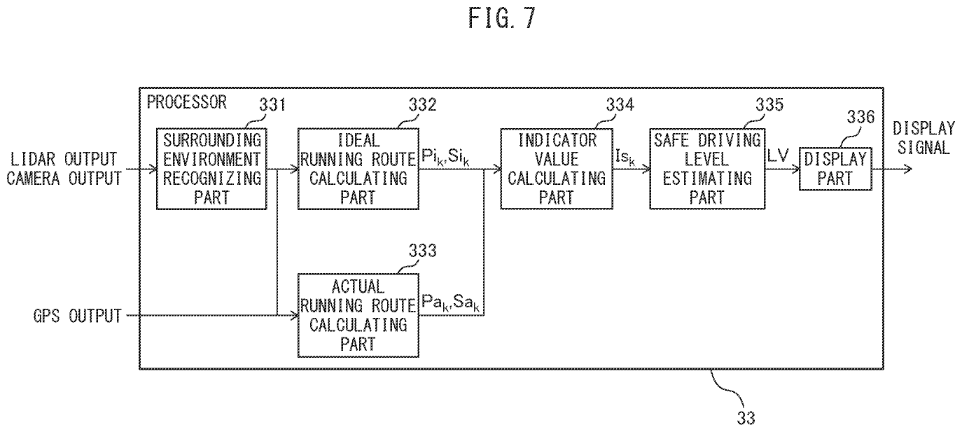

Next, referring to FIG. 7, the specific processing for evaluation of a safe driving level of a driver will be explained. FIG. 7 is a functional block diagram of the processor 33 of the ECU 30 relating to processing for evaluation of a safe driving level of a driver. As shown in FIG. 7, the processor 33 has a surrounding environment recognizing part 331, ideal running route calculating part 332, actual running route detecting part 333, indicator value calculating part 334, safe driving level estimating part 335, and display part 336. These functional blocks of the processor 33 are, for example, functional modules realized by a computer program running on the processor 33. Alternatively, these functional blocks of the processor 33 may be dedicated processing circuits provided at the processor 33.

The surrounding environment recognizing part 331 recognizes the surrounding environment of the vehicle 100 based on the outputs of the various sensors, etc. The surrounding environment recognizing part 331, for example, receives as input images generated by the outside camera 11, measurement results by the distance measurement sensor 12, etc. The surrounding environment recognizing part 331 recognizes the surrounding environment of the vehicle 100 by image recognition processing or recognition processing based on the measurement results (point group data showing distance) by the distance measurement sensor 12. As the recognition processing based on the images or point group data, a neural network, support vector machine, or other known pattern recognition technique is used. The surrounding environment recognizing part 331, specifically, as the surrounding environment, recognizes the types, positions, speeds, etc., of objects in the surroundings of the vehicle 100 (other vehicles, pedestrians, obstacles, etc.), and recognizes information on the road on which the vehicle 100 is running (number of lanes, width of lanes, road conditions, etc.) Note that, the surrounding environment recognizing part 331 may also receive as input, in addition to the images and point group data, the self-position measured by the position measurement sensor 13, map information stored in the storage device 14, and other information. In this case, the surrounding environment recognizing part 331 recognizes the surrounding environment of the vehicle 100 based on these other information in addition to the images and point group data. The surrounding environment recognizing part 331 outputs the information relating to the surrounding environment, and the output information is input to the ideal running route calculating part 332 and the actual running route detecting part 333.

The ideal running route calculating part 332 calculates the ideal running route of the vehicle 100 based on the surrounding environment of the vehicle 100, the self-position measured by the position measurement sensor 13, and the map information stored in the storage device 14. The ideal running route calculating part 332 calculates the ideal running route by, for example, a similar technique as the technique by which an automated driving vehicle determines its running route.

Specifically, the ideal running route calculating part 332 calculates the running route used as the reference, based on the current running state of the vehicle 100 in the case assuming no obstacles in the surroundings of the vehicle 100. The running route used as the reference is calculated based on the self-position of the vehicle 100 and the map information. Further, the ideal running route calculating part 332 corrects the running route used as the reference, to calculate the ideal running route of the vehicle 100, based on the surrounding environment of the vehicle 100 recognized by the surrounding environment recognizing part 331. For example, if a recognized object is a moving body (vehicle or pedestrian etc.), the ideal running route calculating part 332 calculates the future predicted route of the moving body and corrects the running route used as the reference, to calculate the ideal running route, based on the calculated predicted route, so as to avoid the moving body. Further, in correcting the running route used as the reference, the ideal running route calculating part 332 recognizes the type of an object in the surroundings of the vehicle 100, and changes the action for avoiding the object in accordance with the type of the recognized object (for example, changes the width of avoidance for pedestrians and telephone poles etc.)

The ideal running route calculating part 332 basically calculates the ideal running route, based on the surrounding environment of the vehicle 100 and other facets of the outside environment of the vehicle 100. Therefore, the ideal running route after any time once calculated by the ideal running route calculating part 332 does not change until the vehicle 100 passes through the calculated region so long as the outside environment such as the position of a parked vehicle 200 does not change. On the other hand, the ideal running route after any time once calculated by the ideal running route calculating part 332 is changed along with a change in the outside environment, if, for example, the outside environment such as the position of a parked vehicle 200 changes before the vehicle 100 passes through the calculated region.

The ideal running route calculating part 332 outputs the thus calculated information of the ideal running route. Specifically, the information of the ideal running route includes information of the ideal running position Piₖ and the ideal running speed Viₖ for each point Iₖ on the ideal running route expressed as a group of points of a certain interval. The information of the ideal running route output from the ideal running route calculating part 332 is input to the indicator value calculating part 334.

The actual running route detecting part 333 detects the actual running route on which the vehicle 100 actually runs, based on the surrounding environment of the vehicle 100, the self-position measured by the position measurement sensor 13, and the map information stored in the storage device 14. Specifically, the actual running route detecting part 333 detects the general running position of the vehicle 100, based on the self-position measured by the position measurement sensor 13 or the map information, and corrects the running position based on the surrounding environment recognized by the surrounding environment recognizing part 331 (for example, position information of dividing lines etc.) and detailed map information to thereby detect the current actual running position of the vehicle 100. Note that, the actual running route detecting part 333 may also detect the actual running route over which the vehicle 100 has actually run, based on only the self-position measured by the position measurement sensor 13 and the map information stored in the storage device 14. Further, the actual running route detecting part 333 detects the actual running speed of the vehicle 100, based on the changes in the actual running position of the vehicle 100 or the output of the speed sensor 15 detecting the speed of the vehicle 100. The actual running route detecting part 333 outputs information of the thus detected time series actual running position Paₖ and actual running speed Vaₖ of the vehicle 100, as information of the actual running route. The information of the actual running route output from the actual running route detecting part 333 is input to the indicator value calculating part 334.

The indicator value calculating part 334 calculates the safety indicator value, based on the ideal running route and the actual running route. In particular, the indicator value calculating part 334 calculates the safety indicator value Is to become a value showing a lower safe driving level (in the present embodiment, a smaller value) when the difference between the ideal running route and the actual running route is large, compared to when it is small.

The indicator value calculating part 334 receives as input the information of the ideal running route (ideal running position Piₖ and ideal running speed Viₖ) and the information of the actual running route (actual running position Paₖ and actual running speed Vaₖ). Further, the indicator value calculating part 334 specifically calculates the distance ΔPₖ between the running position Piₖ at each point Iₖ of the ideal running route and the running position Paₖ at the corresponding point Aₖ of the actual running route (that is, the running position on the actual running route corresponding to the running position Piₖ of the ideal running route). Further, the indicator value calculating part 334 calculates the safety indicator value, based on the calculated distance ΔPₖ between the two running positions, by using the relationship shown in FIG. 5. Therefore, the indicator value calculating part 334 calculates the safety indicator value so that the longer the distance ΔP between the two running positions, the smaller the safety indicator value Is (that is, so that it becomes a value showing a lower safe driving level). The indicator value calculating part 334 calculates the safety indicator value based on the distance ΔP between two running positions, for all points Iₖ (k=1, 2, . . . , K) in the evaluation section where the safe driving level is evaluated (for example, the section from the start to end of driving).

Further, the indicator value calculating part 334 specifically calculates the speed difference ΔVₖ between the running speed Viₖ at each point Iₖ of the ideal running route and the running speed Vaₖ at the corresponding point Aₖ of the actual running route (that is, the running speed at the running position Paₖ on the actual running route corresponding to the running position Piₖ of the ideal running route). Further, the indicator value calculating part 334 calculates the safety indicator value, based on the calculated speed difference ΔVₖ, using the relationship shown in FIG. 6. Therefore, the indicator value calculating part 334 calculates the safety indicator value Is so that the safety indicator value Is becomes smaller as the speed difference ΔV becomes larger (that is, becomes a value showing a lower safe driving level). The indicator value calculating part 334 calculates the safety indicator value based on the speed difference ΔV, for all points Iₖ (k=1, 2, . . . , K) in the evaluation section.

In addition, the indicator value calculating part 334 calculates the total value of the safety indicator value based on the distance between the two running positions and the safety indicator value based on the speed difference at each point Iₖ, as the safety indicator value Isₖ at that point Iₖ. Further, the indicator value calculating part 334 performs similar processing for all points in the evaluation section to calculate the safety indicator values Is. The indicator value calculating part 334 outputs the thus calculated safety indicator values Is at all of the points in the evaluated section. The safety indicator values Is output from the indicator value calculating part 334 are input to the safe driving level estimating part 335.

The safe driving level estimating part 335 estimates the safe driving level, based on the safety indicator values Is at all points in the evaluated section. The safe driving level estimating part 335 receives as input the safety indicator values Is at all of the points in the evaluated section calculated by the indicator value calculating part 334. Further, the safe driving level estimating part 335 totals up the safety indicator values Is at all of the points in the evaluated section, and estimates the safe driving level so that the safe driving level becomes higher as the total becomes larger. Due to this, the safe driving level is estimated so that the safe driving level is higher as the actual running route is closer to the ideal running route over the entire evaluation section. The safe driving level estimating part 335 outputs information of the estimated safe driving level. The output information is input to the display part 336.

The display part 336 makes a display relating to safe driving level be shown on the display 20 of the vehicle 100. The display part 336 receives as input information of the safe driving level estimated by the safe driving level estimating part 335. The display part 336, for example, makes an indicator 22 be shown so as to be longer as the safe driving level is higher, when the driver finishes driving the vehicle 100. Due to this, the driver can obtain a grasp of the safe driving level of his or her own driving.

Advantageous Effects and Modifications

According to the above embodiments, the safe driving level is calculated to be higher, as the actual running route of the vehicle 100 is closer to the ideal running route calculated by the ideal running route calculating part 332, and is shown on the display. Therefore, according to the present embodiment, a safe driving level evaluation device evaluating a safe driving level of a driver by a new technique is provided. In particular, according to the present embodiment, for example, a safe driving level can be calculated as a different value between a case of stepping hard on the brake to decelerate and temporarily stopping and the case of gradually decelerating and temporarily stopping.

Further, in the above embodiment, the safety indicator value is calculated so that the sign of the safety indicator value inverts between a case where the difference between the ideal running route and the actual running route (that is, the distance between the running position of any point on the ideal running route and the running position of the corresponding point on the actual running route, or the speed difference between the running speed at any point on the ideal running route and the running speed of the corresponding point on the actual running route) is equal to or greater than a predetermined reference difference and a case where it is less than the reference difference. In addition, in the present embodiment, the safe driving level is estimated based on the cumulative value of the safety indicator values calculated in this way in a predetermined section of the running route (evaluation section). As a result, if the actual running route is close to the ideal running route by equal to or greater than any reference, a positive value is calculated as the safe driving level, while if the actual running route is separated from the ideal running route by more than any reference, a negative value is calculated as the safe driving level. As a result, the driver can more easily grasp the safe driving level by the safe driving level inverting in sign in accordance with a certain reference.

Above, a preferred embodiment according to the present invention was explained, but the invention is not limited to this embodiment and can be revised and changed in various ways within the language of the claims.

For example, in the above embodiment, the running route of the vehicle 100 includes the running position and running speed of vehicle 100. However, the running route of the vehicle 100 may also include the running time of day of the vehicle 100 and other parameters, in addition to or in place of the running position and the running speed of the vehicle 100.

Further, in the above embodiment, the safe driving level is calculated based on only the safety indicator value Is calculated based on the running route of the vehicle 100. However, the safe driving level may also be calculated based on parameters other than the safety indicator value Is calculated based on the running route of the vehicle 100, such as the direction of the face or line of sight of the driver while driving the vehicle 100, in addition to the above safety indicator value Is.

1. A safe driving level evaluation device for evaluating a safe driving level of a driver, comprising a processor, wherein
the processor is configured to:
recognize a surrounding environment of a vehicle;
calculate an ideal running route of the vehicle, including an ideal running position and an ideal running speed of the vehicle, based on the recognized surrounding environment;
detect an actual running route of the vehicle, including an actual running position and an actual running speed of the vehicle;
calculate a safety indicator value so that it becomes a value indicating a safe driving level is lower when a difference between the ideal running route and the actual running route is large, compared to when it is small; and
estimate a safe driving level based on the safety indicator value calculated.

2. The safe driving level evaluation device according to claim 1, wherein the processor is configured to make a display relating to the estimated safe driving level be shown on a display of the vehicle.

3. The safe driving level evaluation device according to claim 1, wherein the processor is configured to:
calculate the safety indicator value so that the safety indicator value inverts in sign between a case where a difference between the ideal running route and the actual running route is equal to or greater than a predetermined reference difference and a case where it is less than the reference difference, and
estimate a safe driving level based on a cumulative value of the safety indicator values in a predetermined section of a running route.

4. The safe driving level evaluation device according to claim 1, wherein the processor is configure to calculate the safety indicator value so that the longer the distance between each running position on the ideal running route and the corresponding running position on the actual running route, the lower the safe driving level indicated by the value.

5. The safe driving level evaluation device according to claim 1, wherein the processor is configured to calculate the safety indicator value so that the larger the difference between the running speed at each running position on the ideal running route and the running speed at the corresponding running position on the actual running route, the lower the safe driving level indicated by the value.

6. The safe driving level evaluation device according to claim 1, wherein
the processor is configured to calculate the safety indicator value so that the safety indicator value inverts in sign between a case where a distance between each running position on the ideal running route and the corresponding running position on the actual running route is equal to or greater than a predetermined reference distance and a case where it is less than the reference distance, and
the reference distance changes according to a width of a road or a lane on which the vehicle runs.

7. The safe driving level evaluation device according to claim 1, wherein
the processor is configured to calculate the safety indicator value so that the safety indicator value inverts in sign between a case where a speed difference between a running speed at each running position on the ideal running route and a running speed at the corresponding running position on the actual running route is equal to or greater than a predetermined reference speed difference and a case where it is less than the reference speed difference, and
the reference speed difference changes according to the running speed at the running position of the ideal running route of the vehicle.

8. The safe driving level evaluation device according to claim 1, wherein the processor is configured to calculate the safety indicator value to indicate a lower safe driving level for the same speed difference in a case where a running speed at each running position on the actual running route is faster than the running speed at the corresponding running position on the ideal running route, compared to a case where a running speed at each running position on the actual running route is slower than the running speed at the corresponding running position on the ideal running route.
